(19) United States
(12) Patent Application Publication
(10) Pub. No.: US 2007/0269629 A1
(43) Pub. Date: Nov. 22, 2007

(54) Formulations Useful In The Production Of Anti-Shrink - Copy-Protected Optical Recording Media

(75) Inventor: Richard H. Selinfreund, Terre Haute, IN (US)

Correspondence Address: KELLEY DRYE & WARREN LLP, 400 ALTLANTIC STREET , 13TH FLOOR, STAMFORD, CT, 06901, US

(73) Assignee: Verification Technologies, Inc., Essex, CT (US)

(21) Appl. No.: 11/741,675

(22) Filed: Apr. 27, 2007

Related U.S. Application Data
(60) Provisional application No. 60/745,991, filed on Apr. 28, 2006.

(51) Int. Cl. B32B 3/02

(52) U.S. Cl. 428/64.4

(57) ABSTRACT

Formulations useful in the manufacture of anti-theft and copy-protected digital recording media, in an embodiment comprising a state change material in a hardcoat polymer.

### CROSS-REFERENCE TO RELATED APPLICATIONS

This application claims benefit of U.S. Provisional Application Ser. No. 60/745,991, filed Apr. 28, 2006. The disclosure of each such application is hereby incorporated by reference in its entirety where appropriate for teachings of additional or alternative details, features, and/or technical background, and priority is asserted from each.

### BACKGROUND

1. Field of the Invention

The present invention generally relates to formulations, and methods for the production of formulations, useful in the production of copy-protected and/or shrink-protected optical recording medium. In one embodiment, the formulations comprise optical state change materials, which change optical state upon exposure to an activating source, either permanently, semi-permanently, transiently, or for more than transient periods of time (e.g., more than 1 hour).

2. Description of the Related Art

Methods for copy-protection and shrink-protection of recording media are disclosed in Applicant's prior patent applications. Such methods include the employment of state change materials, including optical state change materials, on or in the recording medium. Such state change materials may be used to change the read of data recorded on the medium. The change in read may in itself, or by software associated with the recording medium, or the reader/hardware associated with the reader, cause the reader to prevent fidelity copying and/or reading of the recording medium. The state change materials can also be used to prevent shrinkage from a distribution chain, that is, theft by unauthorized movement of the recording medium or data associated with the recording medium from the desired distribution chain.

In one anti-shrink embodiment, the state change material is selected such that at least a portion of the data on the recording medium are shielded from fidelity read by the state change material when it is in a first state, but is not shielded from fidelity read when the state change material is in a second state. Activation of the state change material may be by any activation means, including activation by expended energy from the reader itself (such as the laser beam of an optical reader) and activation by an external energy source, such as a select wavelength/sound wave/electromagnetic wave producing device. Upon activation the state change material may move to a second state, or other states, that change the capacity of the reader to read the data.

### DEFINITIONS

“Digital Datum Indicia”: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a digital data read.

“Digital Reader”: any device capable of detecting and reading digital information that has been recorded on an Digital Recording Medium. By the term “reader” it is meant to include, without limitation, a player. Examples are CD and DVD readers.

“Digital Recording Medium”: a medium of any geometric shape (not necessarily circular) that is capable of storing information in digital form thereon. Digital Recording Medium includes, without limitation, CD, DVDs, HD-DVDs, electromagnetic tape and disks, flash drives and Optical Medium. Information stored on the medium may include, without limitation, software programs, software data, sensory files, audio files and video files.

“Light-Activated State-Change Material”: a State-Change Material that alters a measurable parameter upon application of a wavelength, or subwavelength, of light or application of photonic energy to the material.

“Optical Medium”: a medium of any geometric shape (not necessarily circular) that is capable of storing indicia or content that may be read by an optical reader.

“Optical Reader”: a Reader for the reading of Optical Medium.

“Permanent State-Change Material”: a State-Change Material that once activated to change a measurable parameter upon application of energy to the material, stays in such state permanently or for a prolonged period of time.

“State-Change Material”: a material capable of altering a measurable property of the material upon activation of the material by application of energy to the material. “State-Change Material” it is meant to include, without limitation, materials that change in optical state (e.g., opacity and/or color) upon application of energy to the materials, materials that change in electromagnetic state (e.g., electroconductive state) upon application of energy to the materials, and materials that change in physical state (e.g. crystalline to non-crystalline structure, materials that shrink upon application of heat) upon application of energy to the material.

“Temporary State-Change Material”: a State-Change Material that, once activated to change a measurable property of the material upon application of energy to the material, stays in such state for a period of time less than a year.

“Transient State-Change Material”: a State-Change material that, once activated to change a measurable property of the material, spontaneously in a short period of time (minutes or less), loses such change in the measurable property. It includes, without limitation, materials that move from a first state to a second state upon application of energy, and back to the first state without application of energy.

For the purpose of the rest of the disclosure, it is understood that the terms as defined above are intended, whether such terms are in initial capitalization or not.

### SUMMARY OF THE INVENTION

There are disclosed herein formulations useful for protecting a recording medium from illicit copying of data recorded thereon, and from illicit removal of a recording medium from a distribution chain.

There is further disclosed herein, among other embodiments, a state change material formulation that changes state in a manner that such that the state change can be detected by a reader of the recording medium. The state change may be a change in optical state (dark to light, light to dark, reflective to less reflective, transmissive to less transmissive, less transmissive to more transmissive, from one refractive index to another refractive index, etc.).

In one such embodiment, there is provided a reversible or transient optical state change position. Such embodiment may employ a state change material of Formula I: 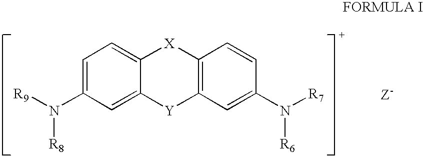
wherein X and Y are independently selected from: S, N, O, and R₆, R₇, R₈ and R₉ are independently selected from: C2-C6 alkyl, or C3-C6 cycloalkyl.

The composition may be formed from a pre-mixture comprising a cross-linkable polymer, such as, for example, a hydroxyl cross-linkable polymer, and a acid generator, and may as well, optionally include, a electron transfer agent/electron donor agent. In one aspect, the cross-linkable polymer is hydroxyethylmethacrylate (HEMA) or a UV curable hard-coat (such as sold by Dainippon Ink and Chemicals, Inc. Japan, a “DIC” hardcoat), and the acid generator is a photon acid generator (such, as “PAG”) or a soluble organic acid such as salicylic acid. “PAG,” one particular photon acid generator composition, is a mixture of the following compounds that generate an acid on the action of radiation:

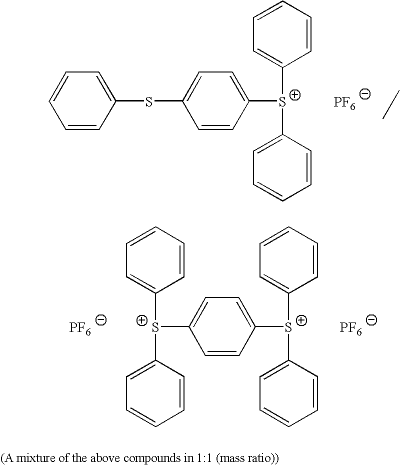

In one pre-mixture embodiment, propylene blue is dissolved in an acidified (such as with salicylic acid) alcohol (such as methoxy propanol) mixture in conjunction with an electron donor agent (ED)/Electron transfer Agent (ETA) (a compound that is electron rich and is capable of providing electrons to the propylene blue molecule in one of its states), such as BisTris (2-hydroxyethyl)iminotris(hydroxymethyl)methane), distributed into a polymerizable polymer, such as HEMA (hydroxyethylmethacrylate). Optionally it may include, for example, Alizarin Red S Fluka (catalogue no. 05600)(C.I. No. 58005) or Coumarin 30 Sigma (catalogue number 546127). Such formulation may be used for producing copy-protected optical medium, such as optical discs.

In another such embodiment, there is provided a one-way change (permanent or semi-permanent) optical state change composition. Such embodiment may employ a state change material of Formula II: 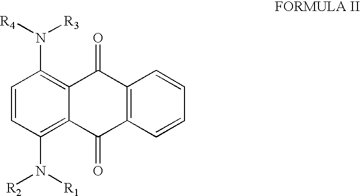
wherein R₁, R₂, R₃ and R₄ are independently selected from: H, C2-C6 alkyl, or C3-C6 cycloalkyl, and a C3-C6 cycloalkyl wherein R₃, R₄ and/or R₁, R₂ are joined to form a ring. The composition may further comprise a binder resin.

In one useful one-way state change anti-shrink application, Sudan Blue is employed in a hardcoat. In the pre-mixture, Sudan blue may be dissolved in an alcohol (such as methoxy propanol) in conjunction with electron donor agent/electron transfer agent(s) and acid generator agent(s), such as triarylsulfonium hexafluorophosphate salt mixed in propylene carbonate, distributed into a polymer, such as HEMA (hydroxyethylmethacrylate). Such embodiment, may alternatively employ, for example, Sudan Blue in a hardcoat, such as a DIC hardcoat, with 3-acetyloxy-2,2-bis(acetyloxymethyl)propyl] acetate (which acts as a photon acid generator). Such formulation may be used to reduce supply chain shrinkage by interfering with data read until activation of the optical state change material to a state that allows for such data read.

Recording media of the described embodiments herein may include only a anti-copy formulation or anti-shrink formulation, or both. Both anti-copy and anti-shrink formulations may be found in the same layer, such as described in the hardcoat, or the anti-copy and anti-shrink formulations may be in distinct layers (which may be, for example, distinct layers in the hardcoat) such that the formulations do not interact directly with one another. As would be understood by one skilled in the art, although described herein with respect to hardcoat formulations, one or none of the formulations may be found in the hardcoat, and one or more, or none, of the formulations may be found in or directly on the recording medium proper.

In another such embodiment, there is provided an optical medium allowing for copy protection and protection against illicit supply chain shrinkage. Such optical medium may employ a one time activation (one-way change) formulation (or multiple formulations that permit a one-way optical state change), and a transient or non-permanent optical state change formulation. In one possible aspect, the medium has several coat layers, one which comprises reversible or transient optical state change composition, such as described above, and the second of which comprises a one-way change composition, such as described above.

In one embodiment having anti-shrink utility, a source other than the reader of the digital recording medium effectuates activation of the state change formulation, and the optical state change is a non-reversible state change. The optical state change material may be, without limitation, formulated so as to eventuate in a one-way transition optical state change (that is moving from a first state to the second state upon activation and therein remaining in the second state without application of energy). As described, such embodiment may further include an anti-copy utility in having a transient or snap-back optical state change (that is moving from the first state to the second state upon activation, and then without application of energy reverting to the first state after a period of time) which is activated by a wavelength that is within the wavelength of the read transmission of the digital reader.

Application of formulations of the present disclosure may be placed on or in association with one or more digital datum indicium. Software may further be included on the medium which requires a certain state change and/or certain state, such as optical state, in order for read to occur. The formulation may comprise a light-activated state change material and/or state change material activated by another activating source such as sound, ultrasound, chemical interaction, electromagnetic wave or other energy source. When a permanent state change material/formulation is applied in an anti-shrink utility, the formulation may be activated from a state wherein the read beam of the digital reader, such as an optical reader, can not read through the formulation, to a state wherein the read beam can read through the formulation, thus allowing, for example, read of the underlying digital datum indicia.

Also disclosed herein is an optical recording medium comprising: (a) first layer comprising a compound of formula I: 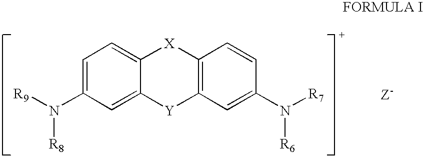
wherein X and Y are independently selected from: S, N, O, and R₆, R₇, R₈ and R₉ are independently selected from: C2-C6 alkyl, or C3-C6 cycloalkyl, and Z⁻ is an anion; a polymeric resin and an electron transfer agent; and a second layer comprising a compound of formula II: 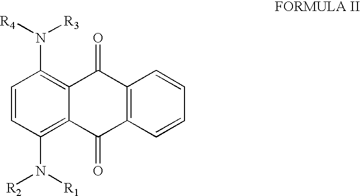
wherein R₁, R₂, R₃ and R₄ are independently selected from: H, C2-C6 alkyl, or C3-C6 cycloalkyl, and a C3-C6 cycloalkyl wherein R₃, R₄ and/or R₁, R₂ are joined to form a ring. In one aspect of such embodiment, when X is N, and Y is S, then R₆, R₇, R₈, and R₉ are C3-C6 alkyl. In another aspect, when R₁, R₂ are H, and R₃ and R₄ are a C4-C6 alkyl or cycloalkyl. The polymeric resin of the first and/or second layer may comprise a hydroxyl cross-linked resin, such as polyHEMA. The electron transfer agent may comprise compounds such as BisTris or other electron donative amines. The second layer may further comprise an acid generator which may be a residual component of the polymerization process. The acid generator may be a number of compounds, and may comprise at least one of the group consisting of triaryl sulfonium hexafluorophosphate, PAG, or an organic acid, such as salicylic acid. In one aspect, the compound of formula I is propylene blue, and the compound of formula II is Solvent Blue 35.

In another embodiment, there is disclosed an optical recording medium comprising a compound of formula II: 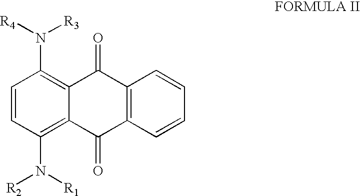
wherein R₁, R₂, R₃ and R₄ are independently selected from: H, C2-C6 alkyl, or C3-C6 cycloalkyl, and a C3-C6 cycloalkyl wherein R₃, R₄ and/or R₁, R₂ are joined to form a ring;
   in a polymeric resin associated with said optical recording medium. In one aspect, the polymeric resin comprises polyHEMA. The optical recording medium may further comprise an acid generator as a residual component of the polymerization. The acid generator may be at least one of the group consisting of triaryl sulfonium hexafluorophosphate, PAG, and an organic acid, such as salicylic acid. The compound of formula II may be Solvent Blue 35.

### DETAILED DESCRIPTION OF ILLUSTRATIVE EMBODIMENTS

In embodiments described herein, there is disclosed a formulation comprising a transient or snap-back optical state change that may be used for copy-protection and digital rights management (DRM) purposes. Such embodiment may employ a state change material of Formula I: 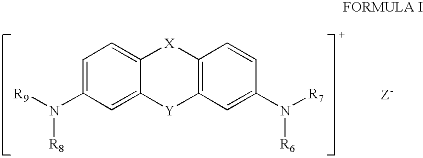
wherein X and Y are independently selected from: S, N, O, and R₆, R₇, R₈ and R₉ are independently selected from: C2-C6 alkyl, or C3-C6 cycloalkyl and Z⁻ is an anion.

In such copy-protection and digital rights management embodiment, the state change may be activated by the read emission, such as optical wavelength, of a digital reader, such as an optical reader. Change is made between a first state and a second state, with the second state reverting to the first state after a period of time. The formulation is applied to portions of, or the whole of, the recording medium. The state change (or any parameter related to the state change) may be monitored by software associated with the recording medium, the reader of the recording medium, or a device, such as a processor, associated with the reader. The software may be designed to allow copy or read of the one or more portions of the recording medium (or the entire medium) only if there is detected the optical state change. Copy protection may also be afforded by inability of the copy algorithms of a device on which the recording medium is read to deal with the differing data reads which may be effectuated by the formulations change in state (such as a change in optical state causing different data reads of underlying digital data indicia).

### EXAMPLE 1

### Copy-Protected—Digital Rights Management Optical Recording Medium Comprising Formulation Causing a Transient Optical State Change

84.9 mls of HEMA are mixed with 182 mls of methoxy propanol. 7.5 grams of Bis Tris, 3.7 g of propylene blue and 5.5 grams of salicylic acid are added to the solution. The formulation is placed on the disc. The disc may be photobleached at 650 nm at 0.5. mW -30 mW approximately 300 more times using a 0.5 mw laser beam from a DVD player (for example, containing an energy of 47.5 microjoules at 1X (time per revolution of 69 ms) through the disc surface).

Software may be used on the disc that restricts read or copying of at least some of the data on the disc unless the transient optical state change is noted. That is, the software may recognize and confirm the activated area of the disc for authentication purposes. Alternatively authoring techniques may be used to restrict read or copying.

In yet another embodiment, there is provide an optical disc designed to reduce supply chain shrinkage. Such embodiment may utilize a one-time activation formulation (does not reverse state in any appreciable manner after activation) that causes a measurable optical state change. Such embodiment may employ a state change material of Formula II: 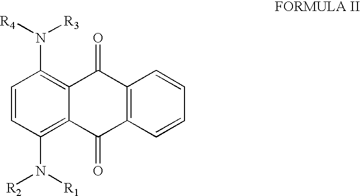
wherein R₁, R₂, R₃ and R₄ are independently selected from: H, C2-C6 alkyl, or C3-C6 cycloalkyl, and a C3-C6 cycloalkyl wherein R₃, R₄ and/or R₁, R₂ are joined to form a ring. The composition may further comprise a binder resin.

Such formulation may be selected to allow activation in the case in which the disc is stored, activation in a few seconds or less, to have a desirable shelf-life permitting activation after manufacture of the recording medium from, for example, about two years or more. When optically activated, such formulation may desirably to be resistant to activation by direct sunlight (e.g., not activated by less than or equal to 24 hours of direct sunlight). The formulation is placed so as to restrict read of at least a portion of the data on the disc until activation to an state permitting such read. For example, the formulation may change optical state, from a state that blocks read to a state that permits read through the formulation.

### EXAMPLE 2

### Supply Chain Anti-Shrink Optical Recording Medium Comprising Formulation I Causing a One-Way Optical State Change

237 mls of HEMA mixed in 10% w/v methoxy propanol (Aldrich Catalogue No. 529265-25) is mixed into 107 mls of methoxy propanol. 30 mls of Triarylsulfonium hexafluorophosphate salts are mixed 50% in propylene carbonate (Aldrich Catalogue No. 407216), a photon acid generator, is added along with 2.7 g of Sudan Blue (Solvent Blue 35—Sigma Catalogue No. 306436; CAS No. 17354-14-2) (“Formulation A”). Formulation A may be modified by adding 3.7 g of Alizarin Red S (Fluka Catalogue Number 05600, C.I. No. 58005) or 3.7 g. of Coumarin 30 (Sigma Catalogue No. 546127).

The formulation, in one embodiment, is applied to in a manner to cause at least a portion of data recorded on an optical disc to be hidden to read from the optical reader while in its first optical state, but not in its activated second optical state.

### EXAMPLE 3

### Supply Chain Anti-Shrink Optical Recording Medium Comprising Formulation II Causing a One-Way Optical State Change

1.5 g of Sudan Blue (Solvent Blue 35 Sigma Catalogue No. 306436; CAS 17354-14-2) is added with 30 mls of PAG and 227.7 ml of DIC hardcoat. The formulation is applied in a manner to cause at least a portion of data recorded on the optical disc to be hidden to read from the optical reader while in its first optical state, but not in its activated second optical state. Application of the hardcoat formulation may be, for example, by a hot mirror.

In an anti-shrink application employing optical recording medium, different end point critical specifications for coating reflectivity before and after activation may be selected. For example the DVD wavelength initial percent reflectivity for a DVD after protective coating may be less than 30% Rf@650 nm before activation with a +/−5% Rf error tolerance being allowed for discs play. A DVD wavelength endpoint after the protective coating is activated at 277 nm for 1 min@1 microwatts/cm² at a distance of 1 meter may be, for example, a reflectivity % of greater than 75% at 650 nm after activation with a +/−5% Rf error tolerance being allowed for the disc to give greater than 95% player compatibility playability. Alternatively, for example, the DVD wavelength initial percent reflectivity for a DVD after protective coating may be less than 30% Rf@405 nm before activation with a +/−5% Rf error tolerance being allowed for discs play. A DVD wavelength endpoint after the protective coating in one embodiment may be activated at 277 nm for 1 min@11 microwatts/cm² at a distance of 1 meter, for example, a reflectivity % of greater than 75% at 405 nm after activation with a +/−5% Rf error tolerance being allowed for the disc to give greater than 95% player compatibility playability. Specifications may also take into account the case holding the disc, such as a Blue BD case that may have 70% transmission at 277 nm.

In yet another embodiment, there is provided an optical medium allowing for copy protection and protection against illicit supply chain shrinkage. Such optical medium may employ multiple formulations that permit a one-way optical state change (one time activation with the optical state change not reversing, either permanently or semi-permanently) in one formulation, but a transient or non-permanent optical state in the other formulation. In such embodiment, the medium may have two or more coat layers, one which comprises reversible or transient optical state change composition, such as described above, and another which comprises a one-way change composition, such as described above. Alternatively, if compatible, the formulations may be in the same layer. Formulations may be selected to allow activation in the case in which the disc is stored, activation in a few seconds or less, to have a desirable shelf life, such as about two years or more, and to be resistant to activation by direct sunlight (e.g., not activated by less than or equal to 24 hours of direct sunlight).

### EXAMPLE 4

### Supply Chain Anti-Shrink Optical Recording Medium Comprising Formulation II Causing a One-Way Optical State Change

A formulation as in Example 1 is used to coat at least a portion of the optical disc. A formulation such as in Example 2 or 3 is then applied to at least a portion of the disc. A DIC hardcoat is then applied. Resultant discs may be exposed to an external activator and be activated, for example, within 1.7 seconds.

### Statement Regarding Illustrative Embodiments

While the invention has been described with respect to certain illustrative embodiments, those skilled in the art will readily appreciate that various changes and/or modifications can be made to the invention without departing from the spirit or scope of the invention as defined by the appended claims.

1. An optical recording medium comprising:
(a) first layer comprising
(1) a compound of formula I: 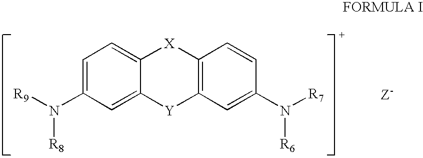
wherein X and Y are independently selected from: S, N, O, and R₆, R₇, R₈ and R₉ are independently selected from: C2-C6 alkyl, or C3-C6 cycloalkyl, and Z⁻ is an anion,
(2) a polymeric resin; and
(3) an electron transfer agent; and
(b) a second layer comprising:
(1) a compound of formula II: 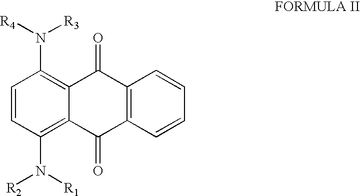
wherein R₁, R₂, R₃ and R₄ are independently selected from: H, C2-C6 alkyl, or C3-C6 cycloalkyl, and a C3-C6 cycloalkyl wherein R₃, R₄ and/or R₁, R₂ are joined to form a ring;
(2) a polymeric resin.

2. The optical recording medium of claim 1 when X is N, and Y is S, then R₆, R₇, R₈, and R₉ are C3-C6 alkyl.

3. The optical recording medium of claim 1 wherein R₁, R₂ are H, and R₃ and R₄ are a C4-C6 alkyl or cycloalkyl.

4. The optical recording medium of claim 1 wherein the polymeric resin comprises polyHEMA.

5. The optical recording medium of claim 1 wherein the electron transfer agent comprises Bis Tris.

6. The optical recording medium of claim 1 further comprising in said second layer a acid generator.

7. The optical recording medium of claim 6 wherein the acid generator is at least one of the group consisting of triaryl sulfonium hexafluorophosphate, PAG, and salicylic acid.

8. The optical recording medium of claim 6 wherein the acid generator is an organic acid.

9. The optical recording medium of claim 1 wherein the compound of formula I is propylene blue.

10. The optical recording medium of claim 1 wherein the compound of formula II is Solvent Blue 35.

11. An optical recording medium comprising:
a compound of formula II 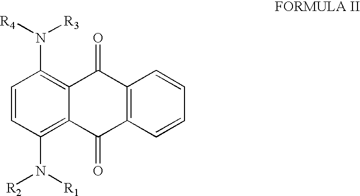
wherein R₁, R₂, R₃ and R₄ are independently selected from: H, C2-C6 alkyl or C3-C6 cycloalkyl, and a C3-C6 cycloalkyl wherein R₃, R₄ and/or R₁, R₂ are joined to form a ring;
in a polymeric resin associated with said optical recording medium.

12. The optical recording medium of claim 11 wherein the polymeric resin comprises polyHEMA.

13. The optical recording medium of claim 11 further comprising an acid generator.

14. The optical recording medium of claim 13 wherein the acid generator is at least one of the group consisting of triaryl sulfonium hexafluorophosphate, PAG, and salicylic acid.

15. The optical recording medium of claim 13 wherein the acid generator is an organic acid.

16. The optical recording medium of claim 11 wherein the compound of formula II is Solvent Blue 35.

17. The optical recording medium of claim 11 further comprising Coumarin 30.

18. The optical recording medium of claim 11 further comprising Alizarin Red S Fluka.
